(19) United States
(12) Patent Application Publication
(10) Pub. No.: US 2011/0128450 A1
(43) Pub. Date: Jun. 2, 2011

(54) ILLUMINATION DEVICE AND LIQUID CRYSTAL DISPLAY DEVICE

(75) Inventor: Takahiro Yoshikawa, Osaka-shi (JP)

(73) Assignee: SHARP KABUSHIKI KAISHA, Osaka-shi, Osaka (JP)

(21) Appl. No.: 13/056,371

(22) PCT Filed: Sep. 30, 2009
(86) PCT No.: PCT/JP2009/067094

§ 371 Date: Jan. 28, 2011

(30) Foreign Application Priority Data
Sep. 30, 2008 (JP) 2008-254403

(51) Int. Cl. H04N 5/50; G02F 1/13357; G02F 1/1335; G09G 3/36

(52) U.S. Cl. 348/731; 362/97.1; 349/62; 345/102; 348/E05.091

(57) ABSTRACT

The present invention provides an illumination device including a plurality of light guides. The illumination device of the present invention can realize improved luminance uniformity. The illumination device of the present invention is a backlight (illumination device) (20) that includes: a plurality of combinations of a light source and a light guide (7) for causing surface emission of light that comes from the light source; and reflecting sheets (reflecting members) (6), each of which faces and covers that surface of corresponding one of the light guides (7) which is an opposing surface of a light emitting surface (7a), each of the reflecting sheets (reflecting members) (6) configured to partially overlap with its adjacent one, in a normal direction of the light emitting surface (7a), over a gap (1) between corresponding two (7, 17) of the light guides which are arranged adjacently to one another so as not to overlap with one another.

### TECHNICAL FIELD

The present invention relates to an illumination device that is used as a backlight of a liquid crystal display device or the like, and to a liquid crystal display device that includes the illumination device.

### BACKGROUND ART

Liquid crystal display devices have increasingly replaced cathode-ray tube (CRT) based display devices. Such liquid crystal display devices have advantages in features such as energy saving, reduced thicknesses, and lightweights. For their advantages, the liquid crystal display devices have been widely used in liquid crystal display televisions, monitors, mobile phones, and the like. One way to utilize the advantages of the liquid crystal display devices is to improve an illumination device (so called a backlight) provided behind a light crystal display device.

Backlights are illumination devices, and are broadly classified into a side light type (also kwon as edge light type) and a direct backlight type. The side light type is configured such that light guides are provided behind a liquid crystal display panel and light sources are provided to edges of the respective light guides. In the configuration, light emitted from a light source is reflected in a corresponding light guide such that the liquid crystal display panel is irradiated with the light indirectly and uniformly. With the configuration, it is possible to realize an illumination device having a reduced thickness and good luminance uniformity although its luminance is low. Thus, a side light type illumination device is mainly employed in a small to medium size liquid crystal display for use in a mobile phone or a laptop personal computer.

One example of the side light type illumination devices is disclosed in Patent Literature 1. Patent Literature 1 discloses a surface-emitting device which includes a light guide having its reflecting surface provided with a plurality of dots so as to allow for uniform light emission from a light-emitting surface. In the surface-emitting device, no light is transmitted to a corner portion of the reflecting surface due to a directivity of a light source, and as such, the corner portion of the reflecting surface is darkened. Patent Literature 1 deals with this by employing an arrangement in which the corner portion of the reflecting surface has a higher dot-density than the remaining part of the reflecting surface.

A direct backlight type illumination device is, on the other hand, configured such that a plurality of light sources are arranged behind a liquid crystal display panel so as to directly illuminate the liquid crystal display panel. As such, it is easier even for a large screen to have high luminance. Therefore, the direct backlight type illumination device is mainly employed in a large size liquid crystal display of 20 inches or larger. However, a currently-available direct backlight type illumination device has a thickness of approximately 20 to 40 mm, and this constitutes a barrier to a further reduction of a thickness of a display.

The large size liquid crystal display can have a further reduced thickness, in a case where light sources and a liquid crystal display panel are provided closer to each other. In the case, however, it is impossible for an illumination device to have luminance uniformity unless a plurality of light sources are provided. Yet, providing of the plurality of light sources increases a cost. In such circumstances, there is a demand for a development of a thin illumination device which can have good luminance uniformity can without the need for the increased number of light sources.

Conventionally, the following attempt has been made in order to solve the problem. Specifically, a plurality of side light type illumination devices are arranged so as so that a the large size liquid crystal display has a reduced thickness.

For example, Patent Literature 2 discloses a surface-emitting device that includes (i) tabular light guide blocks, which partially overlap with one another and thereby have a tandem structure, and (ii) primary light sources, which are provided to the respective corresponding light guide blocks and supply primary light to them. In the surface-emitting device configured as such, it is possible to secure a wide light-emitting area by a compact structure. Thus, the surface-emitting device disclosed in Patent Literature 2 is suitably applicable in a large size liquid crystal display. An illumination device configured as described above, i.e., including an array of a plurality of light emitting units each including a combination of a light source and a light guide, is called as a tandem illumination device.

Patent literatures 3 and 4 disclose respective illumination devices both including a single large size reflecting sheet which is shared by two or more light optical guides.

### CITATION LIST

### Patent Literature 1

Japanese Patent Application Publication, Tokukai, No. 2003-43266 A (Publication Date: Feb. 13, 2003)

### Patent Literature 2

Japanese Patent Application Publication, Tokukaihei, No. 11-288611 A (Publication Date: Oct. 19, 1999)

### Patent Literature 3

Japanese Patent Application Publication, Tokukaihei, No. 5-158036 A (Publication Date: Jun. 25, 1993)

### Patent Literature 4

Japanese Patent Application Publication, Tokukai, No. 2001-092370 A (Publication Date: Apr. 6, 2001)

### SUMMARY OF INVENTION

### Technical Problem

Generally, in each configuration discussed above, light guides are configured to have a minus tolerance, so that it is possible to (i) prevent adjacent light guides from damaging one another, (ii) to realize an illumination device having a reduced thickness, (iii) to tolerate a production error, and the like. However, this causes a gap to be formed in a joint part between adjacent light guides in accordance with a size of the minus tolerance.

The gap thus formed in the joint part due to a drawback of the configuration of the light guides is detected, as a region emitting no light, on a light emitting surface formed by an array of outputting surfaces of the respective light guides. Therefore, there is a problem that in a case where a backlight of a display device is the illumination device including an array of the light guides, generation of luminance unevenness of the light emitting surface causes a deterioration in quality of a display image.

Patent Literature 2 discloses a surface light emitting device of a tandem type. However, Patent Literature 2 pays absolutely no attention to an issue that a gap formed in a joint part between light guides causes a deterioration in quality of a display image. Therefore, Patent Literature 2 does not deal with the gap. Thus, there is a problem that the gap does not emit light at all and thereby causes a dark line to be formed.

Patent Literatures 3 and 4 disclose illumination devices in which a single reflecting sheet is provided in a gap so as to extend across corresponding adjacent light blocks. The illumination devices, however, have a drawback described as follows. In a case where the reflecting sheet is lifted due to thermal expansion or the like, the light guides is deformed accordingly. This increases a risk that luminance unevenness of a light emitting surface is generated.

The present invention is made in view of the problem, and an object of the present invention is to provide an illumination device which includes a plurality of light guides and still realizes improved uniformity in luminance of a light emitting surface.

Another object of the present invention is to provide a liquid crystal display device including the illumination device and thereby having good display quality and a reduced thickness.

### Solution to Problem

In order to attain the object, an illumination device of the present invention includes: a plurality of combinations of a light source and a light guide for causing surface emission of light that comes from the light source; and reflecting members, each of which faces and covers that surface of corresponding one of the light guides which is an opposing surface of a light emitting surface, the reflecting members being configured to partially overlap with their adjacent ones, in a normal direction of the light emitting surface, over a gap between corresponding two of the light guides that are arranged adjacently to one another so as not to overlap with one another. Furthermore, it is preferable that the illumination device of the present invention be configured so that: each of the light guides includes (i) a light emitting section having the light emitting surface and (ii) a light guiding section for directing, to the light emitting section, the light that comes from a corresponding light source; and the light guides are configured so that a light emitting section of one of adjacent two of the light guides is placed on a light guiding section of the other one of the adjacent two of the light guides.

In the invention above, any adjacent two of the reflecting members overlap with each other in the normal direction of the light emitting surface so as to cover the space between the corresponding two of the light guides which are adjacent to each other and arranged so as not to overlap with each other. Thus, any adjacent two of the light guides cover the space, and reflect back light that has left the corresponding two of the light guides, so as to reenter the light into the corresponding two of the light guides. This brings about an effect that causes light use efficiency in the corresponding two of the light guides to be improved. Also, with the invention, it is further possible to cause light use efficiency of a liquid crystal panel to be increased, by reflecting the light back to a liquid crystal panel direction.

In the invention, furthermore, each of the reflecting members faces and covers that surface of corresponding one of the light guides which is an opposing surface of a light emitting surface. That is, each of the light reflecting members is provided to corresponding one of the light guides. This brings about an effect that realizes a reduction in cost, as compared to a backlight in which two reflecting members are used in combination to cover a space between such corresponding two light guides.

It is preferable that the illumination device of the present invention be configured so that each of the reflecting members faces corresponding two or more of the light guides which are adjacent to one another.

In the illumination device of the present invention configured as such, it is possible to (i) reflect back light that has passed through the gap (gap between two light guides which are arranged adjacent to each other and do not overlap with each other), so as to reenter the light into the two light guides, and also to (ii) direct light that has left the two light guides to the liquid crystal panel direction. This brings about an effect that realizes improved light use efficiency. Therefore, the illumination device of the present invention can obtain further improved luminance uniformity of the light emitting surfaces.

Furthermore, it is preferable that the illumination device of the present invention be configured so that each of the reflecting members extends out over a gap between corresponding two of the light guides which are arranged adjacently to one another so as to overlap with one another.

This can prevent a problem that the space (space between corresponding two light guides which are arranged adjacent to each other so as to overlap with each other) becomes a part darker than the light emitting section in a case where no reflecting member extends over the space. Therefore, the illumination device of the present invention configured as such can obtain further improved luminance uniformity of the light emitting surfaces.

Furthermore, it is preferable that the illumination device of the present invention be configured so that each of the reflecting members performs two-side reflection.

This realizes an improved reflectance. Therefore, the illumination device of the present invention configured as such can obtain further improved luminance uniformity of the light emitting sections. This is described specifically as follows. Each of the reflecting members reflects, back into a corresponding light guide 7, light that has passed through an upper surface (which is a surface on a same side as the light emitting surface). As such, each of the reflecting members has a role to cause light use efficiency in a corresponding light guide to be improved.

Furthermore, it is preferable that the illumination device of the present invention be configured so that each of the reflecting members is a reflecting member for performing two-side diffusion reflection, a reflecting member for performing diffusion reflection by one surface and performing mirror reflection by an opposing surface, or a reflecting member for performing two-side mirror reflection.

This makes it possible, in a case where reflecting members are provided for realizing diffusion reflection, to cause a reduction in cost of the illumination device of the present invention. The same makes it possible, in a case where the reflecting members are provided for realizing mirror reflection, to obtain a higher reflectance and improved light reuse efficiency. Therefore, employing of the configuration is advantageous in terms of improvement of luminance uniformity of the light emitting surfaces.

In order to attain the object of the object, an illumination device of the present invention includes: a plurality of combinations of a light source and a light guide for causing surface emission of light that comes from the light source; and reflecting members, each of which faces and covers that surface of corresponding one of the light guides which is an opposing surface of a light emitting surface, the each of the reflecting members being configured to extend out into a gap between corresponding two of the light guides which are arranged adjacently to one another so as not to overlap with one another, and the reflecting members being configured not to overlap with their adjacent ones, in a normal direction of a light emitting surface, in a gap between corresponding two of the light guides that are arranged adjacently to one another so as not to overlap with one another. It is preferable that the illumination device of the present invention be configured so that: each of the light guides includes (i) a light emitting section having the light emitting surface and (ii) a light guiding section for directing, to the light emitting section, the light that comes from a corresponding light source; and the light guides are arranged so that a light emitting section of one of adjacent two of the light guides is placed on a light guiding section of the other one of the adjacent two of the light guides.

In the invention, each of the reflecting members extends over a space between corresponding two of the light guides which are arranged adjacent to each other so as not to overlap with each other. Thus, each of the reflecting members covers the space between corresponding two light guides. Since each of the reflecting members reflects, back into the corresponding two light guides, light that has existed the corresponding two light guides, it is possible to cause light use efficiency in the corresponding two light guides to be improved. In the invention, furthermore, light that has existed the light guides is reflected back to a liquid crystal panel direction. This makes it possible to obtain improved light use efficiency of the liquid crystal panel.

In the invention, furthermore, no adjacent two of the reflecting members overlap with each other, in the normal direction of the light emitting surface, over a space between corresponding two of the light guides which are adjacent to each other so as not to overlap with each other. Thus, the invention is advantageous in terms of assembly ease and workability, since it is easy to perform rework, e.g., exchange of a light guide, a reflecting member, and/or the like.

Furthermore, it is preferable that the illumination device of the present invention be configured so that: each of the reflecting members (i) extends out, by a first width, from one end of corresponding one of the light guides in a direction in which the light guides are arranged adjacently to one another so as not to overlap with one another, and (ii) extends out, by a second width smaller than the first width, from an opposing end of the corresponding one of the light guides in the direction.

In the illumination device of the present invention configured as such, it is thus further easier to (i) assemble (and remove) the light guides in such a manner that any two adjacent light guides are arranged so as not overlap with each other, and (ii) assemble (and remove) the light guides in such a manner that any two adjacent light guides are arranged so as to partially overlap with each other.

Furthermore, it is preferable that the illumination device of the present invention be configured so that each of the reflecting members extends out over a gap between corresponding two of the light guides which are arranged adjacently to one another so as to overlap with one another.

This makes it possible to prevent a problem that the gap (gap between corresponding two of the light guides which are arranged adjacent to each other so as to overlap with each other) becomes a part darker than the light emitting sections in a case where no reflecting member extends over the gap. Therefore, the illumination device of the present invention configured as such can obtain further improved luminance uniformity of the light emitting surfaces.

Furthermore, it is preferable that the illumination device of the present invention be configured so that each of the reflecting members performs two-side reflection.

This realizes an improved reflectance. Therefore, the illumination device of the present invention configured as such can obtain improved luminance uniformity of the light emitting sections. This is described in detail as follows. Each of the reflecting members reflects light that has passed through an upper surface (which is a surface on a same side as a light emitting surface) of a light guiding section of the corresponding light guide, so as to reenter the light into the corresponding light guide. Thus, each of the reflecting members has a role to cause light use efficiency in the corresponding light guide to be improved.

Furthermore, it is preferable that the illumination device of the present invention be configured so that each of the reflecting members is a member for performing two-side diffusion reflection, a member for performing diffusion reflection by one surface and performing mirror reflection by an opposing surface, or a member for performing two-side mirror reflection.

This makes it possible, in a case where the reflecting members are provided for realizing diffusion reflection, to realize a reduction in cost of the illumination device of the present invention. The same makes it possible, in a case where the reflecting members are provided for realizing mirror reflection, to obtain a higher reflectance and improved light reuse efficiency. Therefore, the configuration is advantageous in terms of improvement of luminance uniformity of the light emitting surfaces.

It is preferable that a liquid crystal display device of the present invention include any of the illumination devices as a backlight.

The liquid crystal display device of the present invention configured as such obtains excellent luminance uniformity.

It is preferable that a television receiver device of the present invention includes: a built-in tuner; and a backlight, which is any of the illumination devices.

This causes the television receiver device of the present invention including the built-in tuner to obtain excellent luminance uniformity.

### Advantageous Effects of Invention

As described earlier, an illumination device of the present invention includes: a plurality of combinations of a light source and a light guide for causing surface emission of light that comes from the light source; and reflecting members, each of which faces and covers that surface of corresponding one of the light guides which is an opposing surface of a light emitting surface, the reflecting members being configured to partially overlap with their adjacent ones, in a normal direction of the light emitting surface, over a gap between corresponding two of the light guides that are arranged adjacently to one another so as not to overlap with one another. It is preferable that the illumination device of the present invention be configured so that: each of the light guides includes (i) a light emitting section having the light emitting surface and (ii) a light guiding section for directing, to the light emitting section, the light that comes from a corresponding light source; and the light guides are arranged so that a light emitting section of one of adjacent two of the light guides is placed on a light guiding section of the other one of the adjacent two of the light guides.

As describe earlier, an illumination device of the present invention includes: a plurality of combinations of a light source and a light guide for causing surface emission of light that comes from the light source; and reflecting members, each of which faces and covers that surface of corresponding one of the light guides which is an opposing surface of a light emitting surface, the each of the reflecting members being configured to extend out into a gap between corresponding two of the light guides which are arranged adjacently to one another so as not to overlap with one another, and the reflecting members being configured not to overlap with their adjacent ones, in a normal direction of a light emitting surface, in a gap between corresponding two of the light guides that are arranged adjacently to one another so as not to overlap with one another. It is preferable that the illumination device of the present invention be configured so that: each of the light guides includes (i) a light emitting section having the light emitting surface and (ii) a light guiding section for directing, to the light emitting section, light that comes from a corresponding light source; and the light guides are arranged so that a light emitting section of one of adjacent two of the light guides is placed on a light guiding section of the other one of adjacent two of the light guides.

Therefore, in the illumination device of the present invention, it is possible to obtain improved use efficiency of light passing through light guides. This brings about an effect that obtains an improved uniformity of luminance in a light emitting surface.

### BRIEF DESCRIPTION OF DRAWINGS

FIG. 1 is a cross sectional view showing a configuration of a liquid crystal display device in accordance with one embodiment of the present invention.

FIG. 2 is a top view showing a configuration of a backlight in accordance with the embodiment of the present invention.

FIG. 3 is a top view showing a configuration of a backlight in accordance with the embodiment of the present invention.

FIG. 4 is a top view showing a configuration of a backlight in accordance with the embodiment of the present invention.

FIG. 5 is a cross sectional view showing the configuration of the backlight in accordance with the embodiment of the present invention.

FIG. 6 is a perspective view showing the configuration of the backlight in accordance with the embodiment of the present invention.

FIG. 7 (a) through (b) of FIG. 7 are views showing a conventional backlight and (c) of FIG. 7 is a view showing the backlight of the present invention. (a) of FIG. 7 is a top view showing the conventional backlight. (b) of FIG. 7 is a cross sectional view showing a cross section of the conventional backlight along a line B-B′. (c) of FIG. 7 is a cross sectional view showing a cross section of the backlight in accordance with the embodiment of the present invention.

FIG. 8 is a view schematically showing functional blocks of a television receiver device including an illumination device (backlight) of the present invention and a liquid crystal display device of the present invention.

FIG. 9 is a block diagram showing a relationship between a tuner section of the television receiver device and the liquid crystal display device shown in FIG. 8.

FIG. 10 is an exploded perspective view showing the television receiver device shown in FIG. 8.

### DESCRIPTION OF EMBODIMENTS

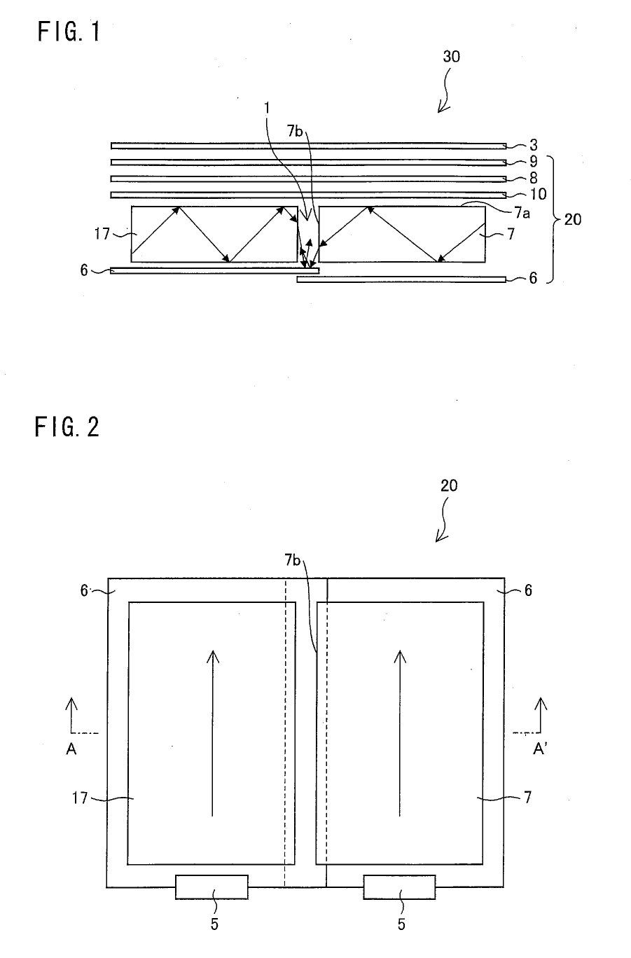

One embodiment of the present invention is described below with reference to FIGS. 1 through 10. The present invention is not limited to the embodiment discussed hereinafter. Sizes, materials, shapes, relative positions of constituents described in the embodiment are merely illustrative, meaning that the scope of the present invention is not limited to them unless otherwise noted.

<Liquid Crystal Display Device>

FIG. 1 is a cross sectional view schematically showing a configuration of a liquid crystal display device 30 that constitutes a television receiver device of the present embodiment or the like. The liquid crystal display device 30 mainly includes a backlight (illumination device) 20, and a liquid crystal display panel 3 provided to face the backlight 20. The television receiver device of the present embodiment is later described.

The liquid crystal display panel 3 is not particularly limited, and is a same liquid crystal display panel as a normal liquid crystal display panel for use in a conventional liquid crystal display device. Though it is not illustrated in FIG. 1, the liquid crystal display panel 3 includes, for example, (i) an active matrix substrate in which a plurality of TFTs (thin film transistors) are provided, (ii) a CF substrate (color filter substrate) that faces the active matrix substrate, and (iii) a liquid crystal layer that is sealed in between the active matrix substrate and the CF substrate by a sealing material.

A configuration of the backlight 20 of the liquid crystal display device 30 is described in detail below.

<Backlight (Illumination Device)>

The backlight 20 is placed behind the liquid crystal display panel 3 (i.e., the backlight 20 is provided closer to a rear surface of the liquid crystal display panel 3 which is an opposing surface to a display surface). As shown in FIG. 1, the backlight 20 mainly includes a light source 5 (which is not shown), a reflecting sheet (reflecting member) 6, a light guide 7 (and a light guide 17), a diffusing plate 8, an optical sheet 9, and a transparent plate 10. The number of light guides in the backlight 20 is two or more. In the present embodiment, the backlight 20 includes two light guides 7 and 17 that are arranged in parallel with each other. However, only the light guide 7 of the two light guides 7 and 17 is described, unless otherwise noted. Configurations of the present invention are shown in FIGS. 1 through 7 in which sizes of members and a distance between light guides 7 and 17 are magnified for easy explanations. The configuration of the reflecting sheet 6 of the backlight 20 is later described.

FIG. 2 is a top view showing a top surface side (a side on which a liquid crystal display panel is provided) of the backlight 20. For an easy explanation, the diffusing plate 8, the optical sheet 9, and the transparent plate 10 are not shown in FIG. 2. FIG. 1 is a cross sectional view showing a part of a cross section of the backlight 20 along a line A-A′ in FIG. 2

The light source 5 is provided so as to face one surface of the light guide 7. The light source 5 is, for example, a light emitting diode (LED) of side emitting type, a cold cathode fluorescent tube (CCFL), or the like. In the present embodiment, there is raised an example in which the light source 5 is an LED. The light source 5 is an LED of side emitting type that has three color chips (i.e., red (R), green (G), and blue (b) color chips) molded in a single package. Use of such LED as the light source 5 makes it possible to realize a backlight having a wide color reproducibility range. The light source 5 is placed on a substrate 11 (which is not shown). The light source 5 is not limited to a dot-like light source.

A combination of the colors of light emitting diodes can be determined as appropriate, based on color properties of color LEDs, a desirable color property of a surface light source device which varies accordingly to a purpose of use of the liquid crystal display device 30, or the like.

The light guide 7 is provided for receiving light coming from the light source 5, and for causing surface emission of the light via a light emitting surface (which is also referred to as a light outputting surface or an outputting surface) 7a. The light emitting surface 7a is a surface for irradiating an irradiation target with light. In the light emitting guide 7, (i) the light emitting surface 7a or (ii) a rear surface or a light emitting section 7c is subjected to treatment and a process so that light directed thereto is outputted in a front direction. Thus, the light directed to the light emitting surface 7a or the rear surface or the light emitting section 7c is emitted from the light emitting surface 7a of the light guide 7 in a direction toward the liquid crystal display device 3. The light guide 7 further includes a light guiding section 7d, which is subjected to treatment and a process. Concrete examples of the treatment and the processes performed for the light guiding section 7d encompass prisming, texturing, printing, and the like. However, the present embodiment is limited to any of them. As such, the treatment and the process can be any known methods as needed.

The light guide 7 is mainly made from a transparent resin such as polycarbonate (PC), polymethyl methacrylate (PMMA), or the like. However, the present embodiment is not limited to this. The light guide 7 is preferably made from a material having a high optical transmittance. The light guide 7 can be prepared by, for example, injection molding, extrusion molding, hot-press molding, cutting, or the like. However, the present embodiment is not limited to any of them. The light guide 7 can be prepared by a processing method exercising a similar effect to the above.

The reflecting sheet 6 is provided so as to face the rear surface (opposing surface to the light emitting surface 7a) of the light guide 7. The reflecting sheet 6 reflects light coming from the light guide 7, so as to cause a greater amount of light to be emitted from the light emitting surface 7a. The reflecting sheet 6 is made from a resin such as foamed PET (polyethylene terephthalate), a mixture of PET and barium sulfate, a mixture of PET and polyolefin, or the like. The reflecting sheet 6 has a thin metal film having a high reflectance, such as silver, aluminum, or the like, which is sputtered on its surface. Among all materials of the reflecting sheet 6, it is preferable to use a PET-based white colored reflecting sheet having an excellent heat stability. The PET-based white colored reflecting sheet is classified, based on its composition, roughly into any of the following types (i) through (iii): (i) a PET-based white colored reflecting sheet prepared by adding a white colored inorganic particle to PET; (ii) a PET-based white colored reflecting sheet prepared by adding, to PET, a resin (olefin-based resin) insoluble to PET; (iii) a PET-based white colored reflecting sheet prepared by impregnating a PET sheet with carbon dioxide or the like and then causing foaming, and the like. In the present embodiment, the reflecting sheet 6 can be any of those types of the PET-based white colored reflecting sheets. However, the present embodiment is not limited to any of the materials described above. The reflecting sheet 6 can be made from any material, provided that a shape of the reflecting sheet 6 can be kept after the reflecting sheet 6 is prepared.

The reflecting sheet 6 has a configuration for realizing two-side diffusion reflection (two-side reflection), one-side diffusion reflection (in this case, the reflecting sheet 6 has one surface for realizing the one-side diffusion reflection and an opposing surfaces for realizing mirror reflection), or two-side mirror reflection. It is preferable that, in a case where the reflecting sheet 6 has the configuration for realizing two-side mirror reflection (two-side reflection), for example, both surfaces of the reflecting sheet 6 be coated by evaporated silver, evaporated aluminum, or the like.

The reflecting sheet 6 can be prepared by, for example, injection molding, press molding, heat-press molding, cutting, or the like. Specifically, in a case where the reflecting sheet 6 is a positive reflecting sheet, (i) at least one surface of the positive reflecting sheet is processed so as to have asperities, or (ii) at least one surface of the positive reflecting sheet has a white pigment applied thereto. This makes it possible to easily provide a diffusing reflecting layer in a desired region of the at least one surface of the positive reflecting sheet. An example of a method for providing asperities in the positive reflecting sheet encompasses a method for providing asperities by injection molding, metal molding, embossing, or the like at same as producing a sheet. Another example of the method encompasses a method for performing prisming, dotting, roughening by a laser, or the like for a surface of the positive reflecting sheet.

In the present embodiment, as shown in FIG. 1, the reflecting sheet 6 is provided so as to face and cover that surface of a corresponding light guide 7 which is an opposing surface of a light emitting surface 7a. The reflecting sheet 6 partially overlaps with an adjacent reflecting sheet 6, in a normal direction of a light emitting surface 7a, over a gap between corresponding two light guides 7 and 17 which are arranged adjacently to each other so as not to overlap with each other.

“The reflecting sheet 6 partially overlaps with an adjacent reflecting sheet 6 in a normal direction of a light emitting surface 7a” indicates that it is satisfactory, irrespective of an overlapping degree, as long as adjacent reflecting sheets 6 overlap with each other.

It is preferable that the reflecting sheet 6 extend from one of the two light guides 7 and 17 to the other one of them.

The reflecting sheet 6 extends out over a gap 1 between corresponding two of light guides 7 which are arranged adjacently to one another so as not to overlap with one another. It is preferable that the reflecting sheet 6 (i) extend out, by a first width, from one end of a corresponding light guide 7 in a direction in which any adjacent two of light guides 7 are arranged so as not to overlap with each other, and (ii) extend out, by a second width smaller than the first width, from an opposing end of the corresponding light guide 7 in the direction.

The diffusing plate 8 faces light emitting surfaces 7a of light guides 7, so as to entirely cover a flat light emitting surface made up of the light emitting surfaces 7a. The diffusing plate 8 is provided so as to (i) diffuse light that has been emitted from the light emitting surfaces 7a and (ii) irradiate the optical sheet 9 with the light thus diffused.

The optical sheet 9 is made up of a plurality of optical sheets that are stacked on one another. The optical sheet 9 is provided so as to (i) uniform and converge the light having been emitted from the light emitting surfaces 7a of the light guides 7, and (ii) irradiate the liquid crystal panel 3 with the light thus uniformed and converged. Therefore, the optical sheet 9 can be made up of sheets such as: a diffusing sheet for converging and diffusing light; a lens sheet for converging light so as to improve luminance of a front direction (liquid crystal display panel direction); and/or a polarized light reflecting sheet for reflecting one polarized light component and passing through the other polarized light component so as to improve luminance of the liquid crystal display device 30, or the like. The sheets are preferably used in combination appropriate in accordance with a price and performance of the liquid crystal display device 30.

The transparent plate 10 is provided in a case where the light guides 7 and the diffusing plate 8 are provided away from each other in a fixed distance. The transparent plate 10 causes a light diffusing region to be formed. The transparent plate 10 is made from a transparent material such as a polyethylene film or the like. The transparent plate 10 is not necessarily provided. As such, no transparent plate 10 may be provided so that the light guides 7 and the diffusing plate 8 face each other.

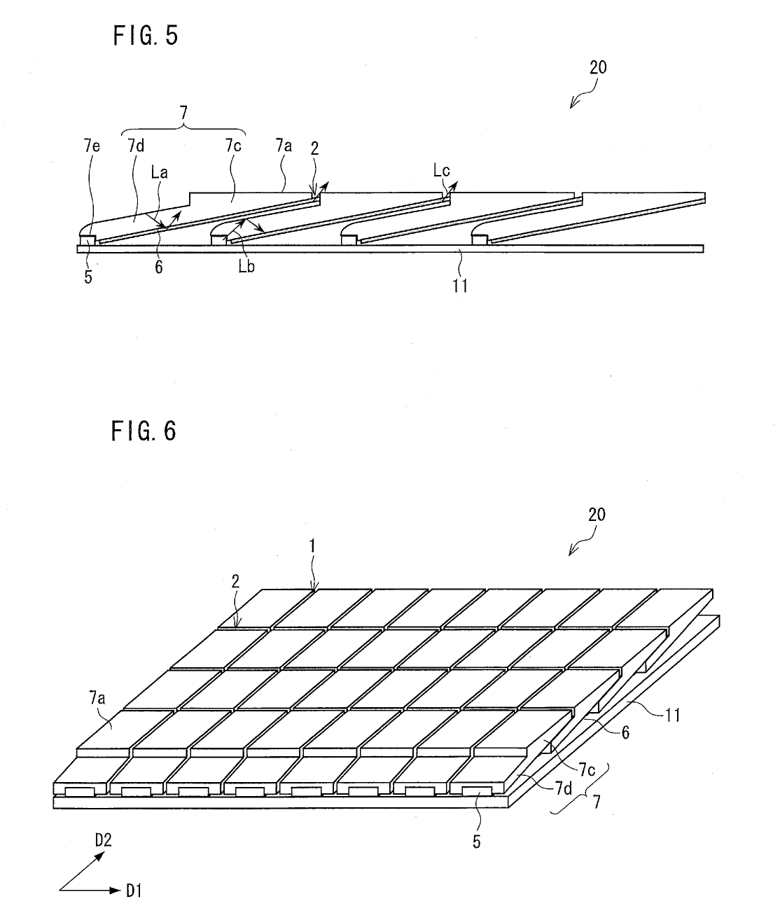

The substrate 11 shown in FIGS. 5 and 6 is provided so as to place the light source 5 thereon. The substrate 11 is preferable white in color so as to realize improved luminance. Even though it is not illustrated in FIGS. 5 and 6, the substrate 11 has a rear surface (which is an opposing surface of a surface on which the light source 5 is mounted) on which drivers for controlling the lighting of LEDs of the light source 5 are mounted. That is, the drivers and the LEDs are mounted on the respective surfaces of the same substrate 11. This brings about an effect that realizes reductions in the number of substrates and the number of connectors for connecting the substrates. Thus, it is possible to realize a reduction in cost of the liquid crystal display device 30. Furthermore, by reducing the number of substrates, it is also possible to realize a reduction in thickness of the liquid crystal display device 30.

By the members configured as such, light coming from the light source 5 (i) passes through within the light guide 7 while being subjected to diffusion and reflection, (ii) leaves the light guide 7 via the light emitting surface 7a, and (iii) passes through the diffusing plate 8, the optical sheet 9, and the like, to be incident on the liquid crystal display panel 3.

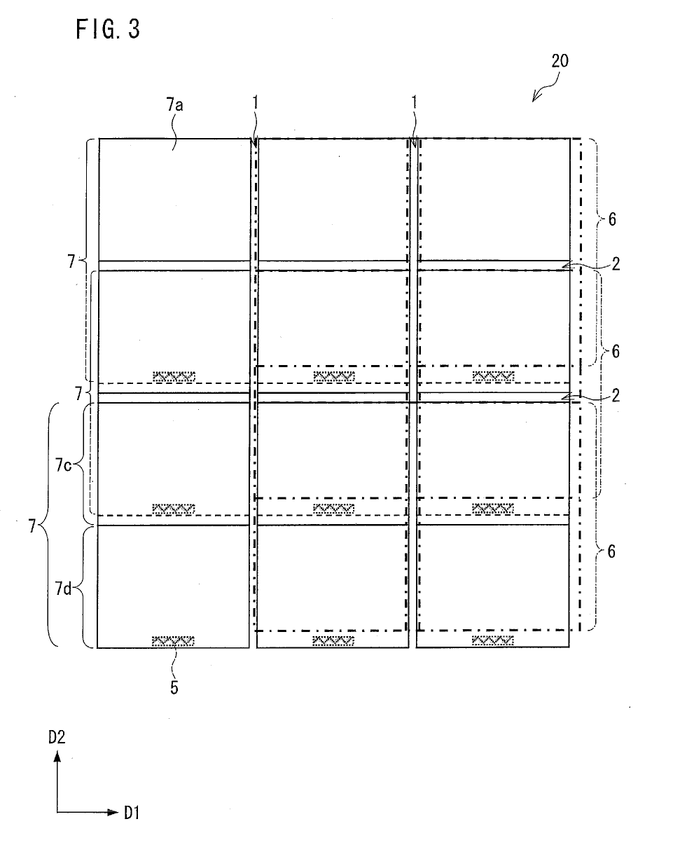

The configuration of the backlight 20 is described in more detail below with reference to FIGS. 3 through 6.

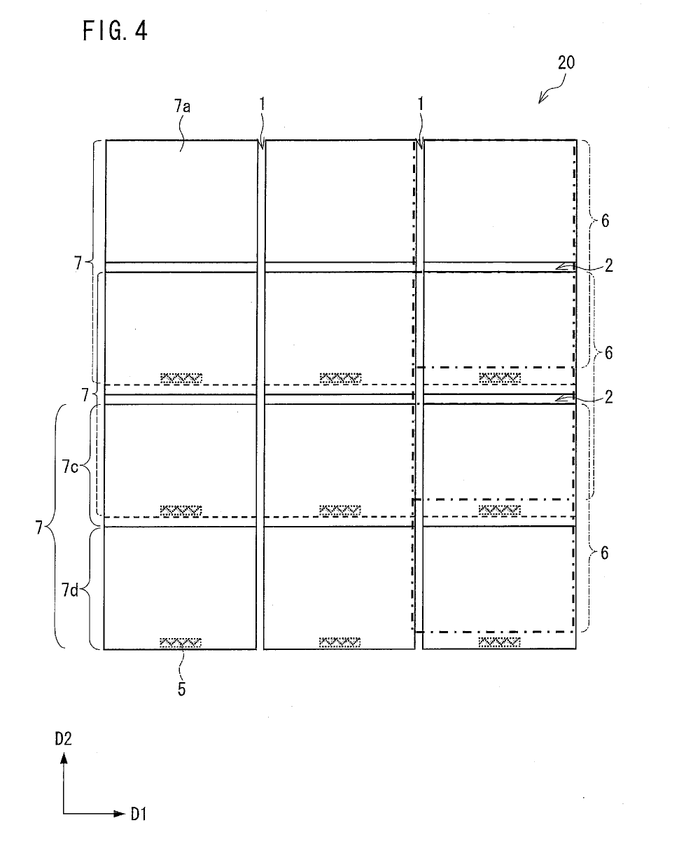

FIGS. 3 and 4 are top views showing, from a light emitting surface 7a, a backlight 20 included in the liquid crystal display device 30 of the present embodiment. FIG. 5 is a side view showing the backlight 20. FIG. 6 is a perspective view sowing the backlight 20.

As shown in FIG. 5, the backlight 20 includes a plurality of light guides 7. Each of the light guides 7 includes (i) a light emitting section 7c having a light emitting surface 7a, and (ii) a light guiding section 7d for directing light coming from the light source 5 to the light emitting section 7c. The plurality of light guides 7 are arranged so that a light emitting section 7c of one of any two adjacent light guides 7 is placed on a light guiding section 7d of the other of any two adjacent light guides 7. The backlight 20 mainly includes the reflecting sheet 6, the light source 5, and the substrate 11 for placing the light sources thereon. The backlight 20 configured as such functions to cause surface emission of the light coming from the light sources 5.

<Light Guide>

As described earlier, light guides are normally produced to have a minus tolerance, so that it is possible to (i) prevent light guides from damaging one another, (ii) realize a reduction in thickness of a backlight, (iii) tolerate a production error, or the like. This, however, causes gaps to be formed in joint parts between any adjacent two of the light guides, based on the minus tolerance. The gaps are seen, on a light emitting surface made up of light emitting surfaces of an array of the light guides, as a region emitting no light. A backlight including an array of such light guides may be used as a backlight of a display device. This, however, causes luminance unevenness of the light emitting surface, and thereby causes a deterioration in quality of a display image.

In the backlight 20 included in the liquid crystal display device 30 of one embodiment of the present invention, there are two variations of gaps due to differences in mechanisms how they are formed. As described below, the two variations of gaps are (i) a gap formed between any adjacent two of light guides 7 which are arranged so as not overlap with one another, and (ii) a gap formed between any adjacent two of light guides 7 which are arranged so as to partially overlap with one another. As shown in FIGS. 3, 4, and 6, a direction D2 is a direction in which a light emitting section 7c of one of any adjacent two of the light guides 7 is placed on a light guiding section 7d of the other one of the any adjacent two of the light guides 7. In the direction D2, therefore, any adjacent two of the light guides 7 are arranged so as to partially overlap with each other. A direction D1 is a direction intersectional to (approximately perpendicular to) the direction D2. In the direction D1, any adjacent two of the light guides 7 are arranged so as not to overlap with each other.

(Gap Between Light Guides which are Arranged so as Not to Overlap with Each Other)

“A gap between any adjacent two of light guides which are arranged so as not to overlap with one another” is a gap between any adjacent two of a plurality of light guides which are arranged in a same plane so as not to overlap with one another. Specifically, as shown in FIGS. 3, 4, and 6, “a gap 1 between any adjacent two of light guides 7 which are arranged so as not to overlap with one another” is a gap 1 between any adjacent two of light guides 7 which are arranged in the direction D1. That is, among the light guides 7 which are arranged in the direction D1, there are absolutely no adjacent light guides 7 which partially overlap with each other. In this case, it is possible that a reflecting sheet 6 extend over a gap 1 between corresponding two of the light guides 7, so as to cover the gap 1.

In the backlight 20 included in the liquid crystal display device 30 of the one embodiment of the present invention, the reflecting sheet 6 overlaps with an adjacent reflecting sheet, in a normal direction of a light emitting surface 7a, over the gap 1. This brings about an effect that (i) reenters light, which has leaked from a side surface 7b of a light guide 7, into the light guide 7 (or a light guide 17) with higher certainty by using the two reflecting sheets 6, and (ii) reflects the light to the liquid crystal display panel 3. It is therefore possible to obtain improved light use efficiency and cause a dark line to be less detectable.

(Gap Between Light Guides Arranged so as to Partially Overlap with Each Other)

“A gap between any adjacent two of light guides which are arranged so as to partially overlap with one another” is described below. For example, each of the light guides includes (i) a light emitting section having a light emitting surface (outputting surface) and (ii) a light guiding section for directing light coming from a light source to the light emitting section. The light guides are arranged so that a light emitting section of one of any adjacent two of the light guides is placed on a light guiding section of the other one of any adjacent two of the light guides. This causes a gap to be formed in a joint part between light emitting surfaces of the respective adjacent two of the light guides. The gap is “the gap between any adjacent two of light guides which are arranged so as to partially overlap with one another”.

In the present embodiment, it is preferable that a reflecting member be provided so as to extend over a gap between corresponding two of the light guides which are arranged adjacent to one another so as to partially overlap with one another.

Similarly to “the gap between any adjacent two of light guides which are arranged so as not to overlap one other”, “the gap between any adjacent two of light guides which are arranged so as to partially overlap with one another” causes a part darker than the light emitting sections to be formed, since no reflecting sheet extends over the gap.

This is described in detail as follows. In a case where a light emitting section 7c of one of any adjacent light guides 7 is placed on a light guiding section 7d of the other one of any adjacent light guides 7, as shown in FIGS. 3, 4, and 6, “the gap between any adjacent two of light guides which are arranged so as to partially overlap with one another” is a gap 2 formed in a joint part between light emitting surfaces 7a of the respective adjacent light guides 7. That is, “the gap between any adjacent two of light guides which are arranged so as to partially overlap with one another” is a gap 2 between any adjacent two of the light guides which are arranged in the direction D2. The gap 2 causes a region emitting no light to be formed. In order to reduce the region, it is necessary to lengthen a reflecting sheet 6 by a certain degree so that the reflecting sheet 6 extends out, in the direction (the direction D2) in which the light guides are arranged so as to overlap with one another, over the gap 2.

Even in a case of lengthening the reflecting sheet 6 in the direction D2 so that the reflecting sheet 6 covers a part of the gap 2, it is still possible to bring about an effect that prevents, to some extent, the region from causing a dark line. However, in a case of maximizing the length of the reflecting sheet 6 in the direction D2, i.e., extending the reflecting sheet 6 from a corresponding light guide 7 to a boundary between a light guiding section 7c and a light emitting section 7c of an adjacent light guide 7, so that the reflecting sheet 6 covers an enter part of the gap 2, it is possible to maximize the effect that reduces the dark line.

In the light guides 7, light that enters a light guide 7 from an incidence surface 7e facing a light source 5 should be emitted from a light emitting surface 7a with good efficiency. For this, it is necessary that light loss to be caused in a light guiding section 7d of the light guide 7 be minimized.

Thus, the light guiding section 7d should be so that its upper and lower surfaces are substantially parallel with each other. This allows incoming light to be directed within the light guiding section 7d while satisfying a total reflection condition. Therefore, the light guiding section 7d can prevent an amount of light directed therein from being reduced.

Any adjacent light guides 7 incline with respect to the optical sheet 9, which is a surface to be irradiated with light, and overlap with each another. Thus, in each of the light guides 7, a light emitting surface 7a is not parallel with an opposing surface thereto. Therefore, the light guide 7 has a shape tapered toward a direction extending away from a corresponding light source 5.

By the configuration, light being directed within the light guide 7 (i) gradually fails to satisfy the total reflection condition as it travels away from the light source 5, and therefore, (ii) exits the light guide 7 via the light emitting surface 7a.

<Reflecting Sheet (Reflecting Member)>

As shown in FIGS. 3 through 6, the reflecting sheet 6 is provided so as to face and cover that surface of a corresponding light guide 7 which is an opposing surface of a light emitting surface 7a. In FIGS. 3 and 4, only a part of the reflecting sheet 6 is shown while some other parts of the reflecting sheet 6 are omitted, so that the views in FIGS. 3 and 4 can be simplified.

FIG. 3 is a top view showing, from a light emitting surface 7a, a backlight 20 in which a reflecting sheet 6 (i) extends out, by a first width, from one end of a corresponding light guide 7 in a direction in which light guides 7 are arranged adjacently to one another so as not to overlap with one another, and (ii) extends out, by a second width same as the first width, from an opposing end of the corresponding light guide in the direction.

Specifically, in FIG. 3, two reflecting sheets 6 (in FIG. 3, which are (i) a reflecting sheet 6 for a light guide 7 in a rightmost line of light guides 7 and (ii) a reflecting sheet 6 for a light guide 7 in a middle line of light guides 7; in FIG. 3, no reflecting sheet 6 for a light guide 7 in a leftmost line of light guides 7 is shown) partially overlap with each other over a gap 1 (in FIG. 3, which is a gap 1 between the light guide 7 in the rightmost line of light guides 7 and the light guide 7 in the middle line of the light guides 7).

FIG. 4 is a top view showing, from a light emitting surface 7a, a backlight 20 in which a reflecting sheet 6 (i) extends out, by a first width (which is, in FIG. 4, a width of a left part of a reflecting sheet 6 for a rightmost line of light guides 7), from one end of a corresponding light guide 7 in a direction in which light guides 7 are arranged adjacently to one another so as not to overlap with one another, and (ii) extends out, by a second width (which is, in FIG. 4, a width of a right part of the reflecting sheet 6) smaller than the first width, from an opposing end of the corresponding light guide 7 in the direction.

Specifically, in FIG. 4, the left part of the reflecting sheet 6 for the rightmost line of the light guides 7 (which is, in FIG. 4, the reflecting sheet 6 for the rightmost line of the light guides 7; in FIG. 4, neither a reflecting sheet 6 for a middle line of light guides 7 nor a reflecting sheet 6 for a leftmost line of light guides 7 is shown) is greater in width than the right part of the reflecting sheet 6. Thus, the left part of the reflecting sheet 6 does not overlap with a reflecting sheet 6 (which is not shown in FIG. 4) for the middle line of light guides 7 over a gap 1 (which is, in FIG. 3, a gap 1 between the rightmost line of light guides 7 and the middle line of light guides 7).

The reflecting sheet 6 reflects back light that has left a corresponding light guide 7 via an opposing surface to a light emitting surface 7a, so as to reenter the light in the light guide 7. As such, the reflecting sheet 6 has a role to cause light use efficiency in the light guide 7 to be improved. This is described in more detail as follows. As shown in FIG. 5, the reflecting sheet 6 reflects back light La that has exited the light guide 7, so as to reenter the light La in the light guide 7 at an angle of incidence not greater than a total reflection critical angle with respect to a normal line of the opposing surface to the light emitting surface 7a. Note that the total reflection critical angle is determined by a material from which the light guide 7 is made.

Furthermore, as shown in FIGS. 1 and 2, the reflecting sheet 6 extends over a space between corresponding two of the light guides 7 which are arranged adjacently to one another so as not to overlap with one another. The reflecting sheet extending as such covers a gap 1 between the corresponding two of the light guides 7.

In the present embodiment, as shown in FIGS. 1 and 2, the reflecting sheet 6 thus extends over the space between the corresponding two of the light guides 7, so as to cover the gap 1 between them. This can prevent a problem that in a case where no reflecting sheet 6 extends over the gap 1, the gap 1 causes a part darker than light emitting sections 7c to be formed.

In the present embodiment, furthermore, the reflecting sheet 6 extends so as to cover a gap 2 between corresponding two of light guides 7 which are arranged adjacently to one another so as to partially overlap with one another. Therefore, as shown in FIG. 5, it is further possible to emit reflected light Lc from the gap 2. This can prevent a problem that in a case where no reflecting sheet 6 extends over the gap 2, the gap 2 causes a part darker than the light emitting sections 7c to be formed. It is therefore possible to realize the backlight 20 that can obtain further improved luminance uniformity of a light emitting surface.

It is preferable that, in the backlight 20 included in the liquid crystal display device 30 of one embodiment of the present invention, (i) the reflecting sheet 6 extend so as to cover at least a plane where a light emitting section 7c of one of adjacent light guides 7 is in contact with a light guiding section 7d of the other one of the adjacent light guides 7, and (ii) the reflecting sheet 6 be made up of a two-side reflecting sheet.

As shown in FIG. 5, the reflecting sheet 6 configured as such reflects back light Lb that has passed through an upper surface (which is a surface on a same side as the light emitting surface 7a) of the light guiding section 7d, so as to reenter the light Lb into the light guide 7. As such, the reflecting sheet 6 has a role to cause light use efficiency in the light guide 7 to be increased. Normally, the reflecting sheet 6 reflects back the light Lb that has left the light guide 7, so as to reenter it in the light guide 7 at an angle not greater than a total reflection critical angle with respect to a normal line of the upper surface (which is the surface on the same side as the light emitting surface 7a) of the light guising section 7d. Note that the total reflection critical angle is determined accordingly to a material from which the light guide 7 is made.

That part of the reflecting sheet 6, which faces that surface of the light guide 7 which is an opposing surface to the light emitting surface 7a, has a reflectance that may or may not be same with a reflectance of another part of the reflecting sheet 6 which extends over the gap 1 or 2. That is, the reflectances of the respective parts of the reflecting sheet 6 are not particularly limited, provided that the reflecting sheet 6 can reflect light back into the light guides 7.

<Uniformity in Luminance>

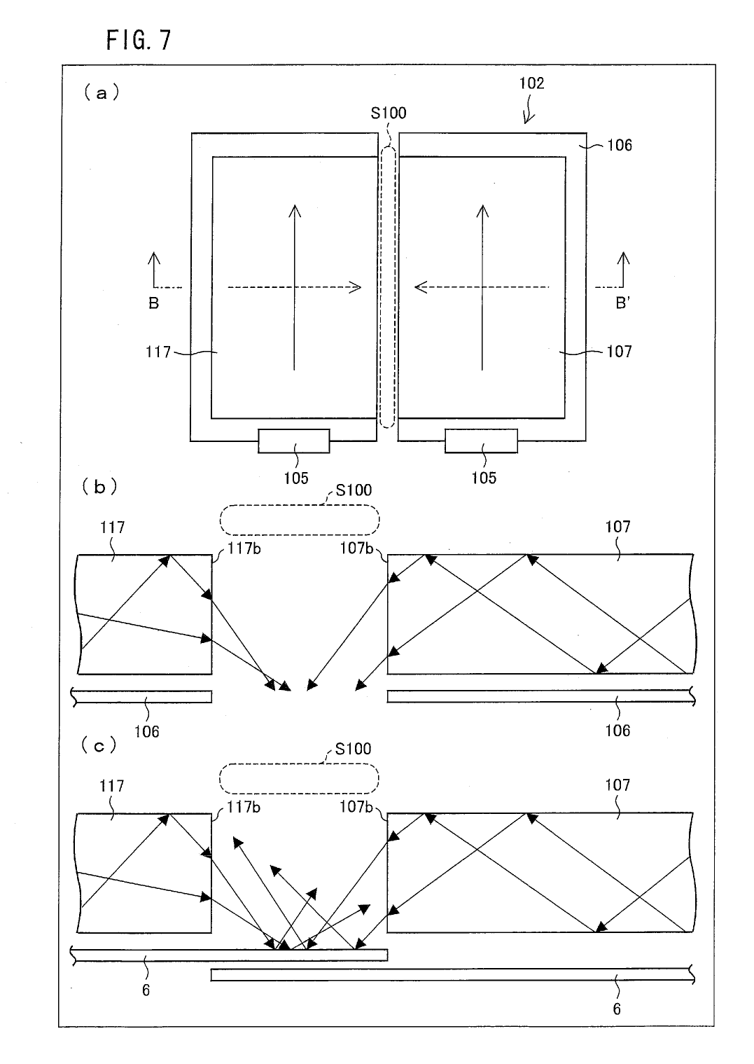

With reference to FIG. 7, the following description discusses a principle how luminance unevenness is caused, and a principle which luminance uniformity is improved.

(a) and (b) of FIG. 7 are views showing a conventional backlight 102. Specifically, (a) of FIG. 7 is the view showing a top of the conventional backlight 102, and (b) of FIG. 7 is the view showing a cross section of the conventional backlight 102 along a line B-B′ shown in (a) of FIG. 7. For easy explanations, no member other than a light source, a light guide, and a reflecting sheet is shown in (a) and (b) of FIG. 7.

In the conventional backlight 102, a light guide 107 receives light coming from a light source 105. In the light guide 107, most of the light thus received is directed to a direction (which is shown by a solid arrow line in (a) of FIG. 7, and hereinafter referred to as a light axis direction) which is parallel to a direction of a normal line of an irradiation surface of the light source 105. On the other hand, a relatively small amount of the light thus received is directed to a direction (which is shown by a dashed arrow line in (a) of FIG. 7) which is orthogonal to the light axis direction and parallel to a direction of the light emitting surface of the light guide 107. Therefore, only a small amount of light reaches a region (gap) S100 between the light guides 107 and 117. As such, the region S100 has a reduced luminance. This causes unevenness in luminance of the backlight 102.

This is described in detail as follows. As shown in (b) of FIG. 7, no conventional reflecting sheet 106 extends over an opposing region to the region S100 formed between light guides 107 and 117. This is for avoiding a risk that, in a case where the conventional reflecting sheets 106 are thermal expanded so as to be lifted up, the light guides 107 and 117 are deformed accordingly so that luminance unevenness of light emitting surfaces of the light guides 107 and 117 is caused. Employing of such countermeasure, however, causes a problem that light having passed through side surfaces 107b and 117b of the light guides 107 and 117 externally leaves the backlight 102.

In order to solve the problem, it can be thought to provide separate pieces (i.e., not combined to each other) of reflecting sheets 6 in a backlight, so that the separate pieces of the reflecting sheets 6 extend over the opposing region to the region S100, in addition of facing the respective light guide 107 and 117. In this case, as shown in (c) of FIG. 7, a part of light having passed through side surfaces 107b and 117b of the light guides 107 and 117 is reflected by a surface of the reflecting sheet 6, and reenters the light guides 107 and 117. This brings about an effect that increases luminance of the region S100. Thus, it is possible to prevent luminance unevenness from being caused, and thereby to prevent a decrease in uniformity of luminance of the backlight.

Thus, the backlight as shown in (c) of FIG. 7 realizes improved luminance uniformity. Furthermore, as shown in (c) of FIG. 7, the reflecting sheets 6 are separated from each other (i.e., not combined to each other). Therefore, it is thought that the reflecting sheets 6 will not be lifted up even in a case where they are thermal expanded, or in the like case.

Regarding the gap 1 between two adjacent light guides 107 and 117 which are arranged so as not to overlap with each other, it is preferable that:

d≧D;

where d is a size of the gap 1, and D is a size of that part of the reflecting sheet 6 which extends out from one end of the light guide 107 or 117. Note that d≧D is satisfied by only that part of the reflecting sheet 6 which extends out from the one end of the light guide 107 or 117. This is because the configuration makes it possible to, in a case where a part of the backlight emits no light due to assembly error, a failure of a member, or the like, easily remove only the part of the backlight.

The illumination device (backlight) of the present invention is advantageous in terms of luminance uniformity of a large light emitting area realized by an array of plural light guides. As such, it is preferable that the illumination device of the present invention be used particularly as a backlight of a liquid crystal display device having a large-size screen. However, the present invention is not limited to this. Instead, the illumination device of the present invention can be used as a backlight of a various type of liquid crystal display devices, or the like.

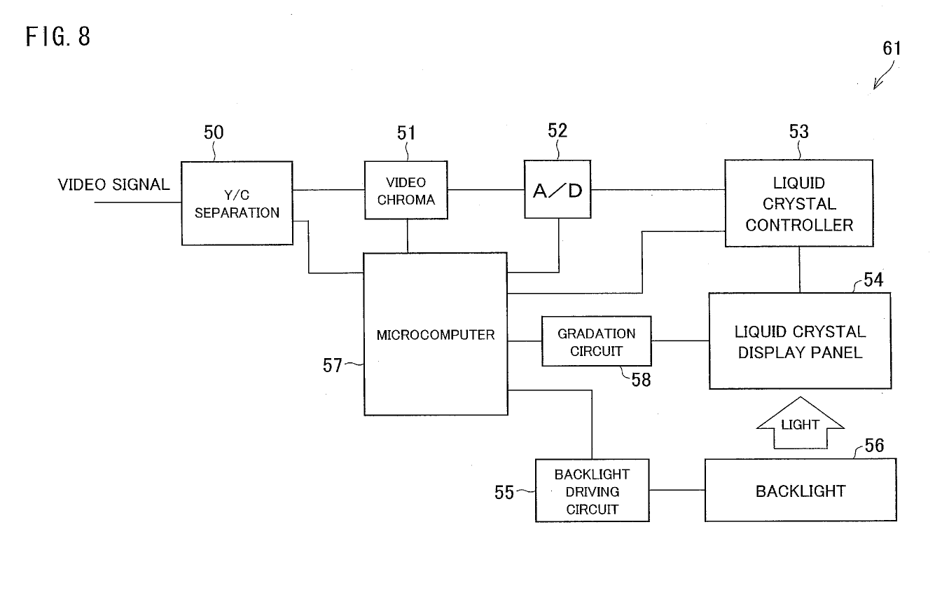

With reference to FIGS. 8 through 10, the following description discusses a television receiver device including (i) the illumination device (backlight) of the present invention and (ii) a liquid crystal display device.

FIG. 8 is a view showing a circuit block of a liquid crystal display device 61 for use in the television receiver device. As shown in FIG. 8, the liquid crystal display device 61 mainly includes a Y/C separation circuit 50, a video chroma circuit 51, an A/D converter 52, a liquid crystal controller 53, a liquid crystal display panel 54, a backlight (illumination device) driving circuit 55, a backlight (illumination device) 56, a microcomputer 57, and a gradation circuit 58.

The liquid crystal display panel 54 includes a first liquid crystal display panel and a second liquid crystal display panel, and can have any of the configurations described earlier.

In the liquid crystal display device 61 configured as such, at first, the Y/C separation circuit 50 receives a television signal as an input video signal, and separates a luminance signal and a color signal from it. The luminance signal and the color signal are sent to the video chroma circuit 51, and converted to an analogue RGB signal indicative of three primary colors in light. Then, the analogue RGB signal is sent to the A/D converter 52, and converted to a digital RGB signal. Then, the digital RGB signal is inputted to the liquid crystal controller 53.

The liquid crystal display panel 54 receives (i) the digital RGB signal inputted from the liquid crystal controller at given timings, and (ii) corresponding gradation voltages to R, G, and B values from the gradation circuit 58. In response to the digital RGB signal and the gradation voltage thus received, the liquid crystal display panel 54 displays an image. Control of an entire system, inclusive of control of the processes above, is carried out by the microcomputer 57.

The video signal can a video signal of an image on television broadcasting, a video signal of an image captured by a camera, and a video signal of an image supplied via the Internet network, a video signal of an image recorded on DVD, or the like. The liquid crystal display panel 54 can display an image in response to such wide variety of video signals.

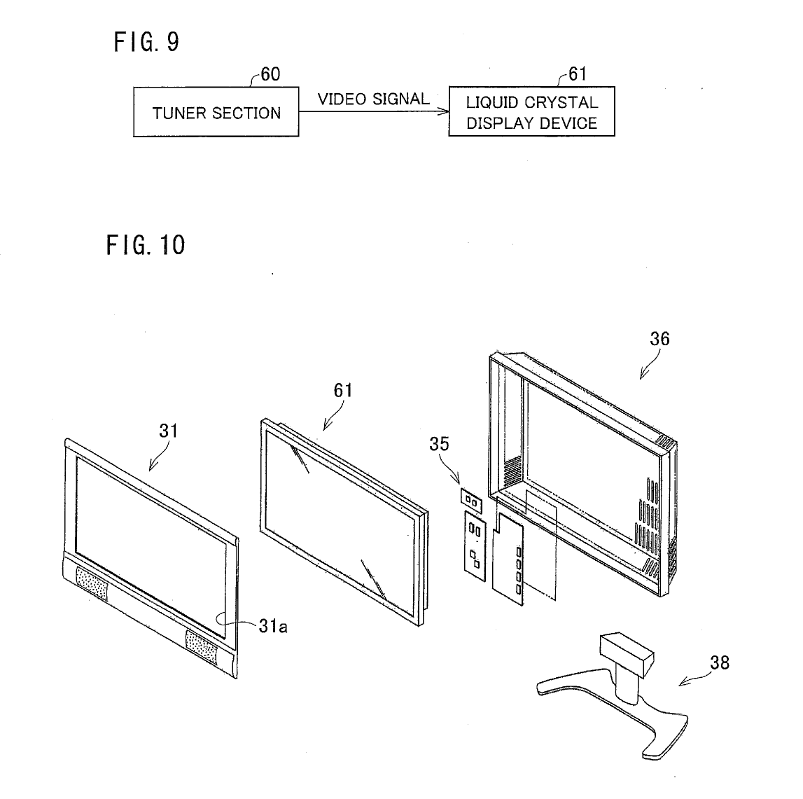

The tuner section 60 shown in FIG. 9 receives a television broadcast, and outputs a corresponding video signal to the liquid crystal display device 61. In response, the liquid crystal display device 61 displays an image (or video) in accordance with the video signal thus received.

The liquid crystal display device 61 may constitute a television receiver device. In this case, for example, the liquid crystal display device 61 is sandwiched by a first chassis 31 and a second chassis 36 so as to be housed in between them.

The first chassis 31 has an aperture 31a via which an image displayed on the liquid crystal display device 61 is transmitted.

The second chassis 36 is provided for covering a rear surface of the liquid crystal display device 61. The second chassis 36 is provided with (i) an operation circuit 35 for operating the liquid crystal display device 61, and (ii) a supporting member 38 attached to a bottom of the second chassis 36.

The present invention is not limited to any of the aforementioned embodiments, but can be altered within the scope of the following claims. That is, an embodiment realized by combining technical means modified as appropriate within the scope of the claims is included within the technical scope of the present invention.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is applicable to (i) an illumination device for use in a backlight of a liquid crystal display device or the like, (ii) a liquid crystal display device including the illumination device, and (iii) a television receiver device with a built-in a tuner, or the like.

### REFERENCE SIGNS LIST

1. gap
2. gap
3. liquid crystal display panel
5. light source
6. reflecting sheet (reflecting member)
7. light guide
7a. light emitting surface
7b. side surface
7c. light emitting section
7d. light guide section
7e. light incidence surface
8. diffusing plate
9. optical sheet
10. transparent plate
11. substrate
17. light guide
20. backlight (illumination device)
30. liquid crystal display device
102. backlight (illumination device)
105. light source
106. reflecting sheet
107. light guide
107b. side surface
117. light guide
117b. side surface
31. first housing
31a. opening
35. operation circuit
36. second housing
38. supporting member
50. Y/C separation circuit
51. video chroma circuit
52. A/D converter
53. liquid crystal controller
54. liquid crystal display panel
55. backlight (illumination device) driving circuit
56. backlight (illumination device)
57. microcomputer
58. gradation circuit
60. tuner section
61. liquid crystal display device

1. An illumination device, comprising:
a plurality of combinations of a light source and a light guide for causing surface emission of light that comes from the light source; and
reflecting members, each of which faces and covers that surface of corresponding one of the light guides which is an opposing surface of a light emitting surface, the reflecting members being configured to partially overlap with their adjacent ones, in a normal direction of the light emitting surface, over a gap between corresponding two of the light guides that are arranged adjacently to one another so as not to overlap with one another.

2. The illumination device as set forth in claim 1, wherein:
each of the light guides includes (i) a light emitting section having the light emitting surface and (ii) a light guiding section for directing, to the light emitting section, the light that comes from a corresponding light source; and
the light guides are configured so that a light emitting section of one of adjacent two of the light guides is placed on a light guiding section of the other one of the adjacent two of the light guides.

3. The illumination device as set forth in claim 1, wherein:
each of the reflecting members faces corresponding two or more of the light guides which are adjacent to one another.

4. The illumination device as set forth in claim 2, wherein:
each of the reflecting members extends out over a gap between corresponding two of the light guides which are arranged adjacently to one another so as to overlap with one another.

5. The illumination device as set forth in claim 1, wherein:
each of the reflecting members performs two-side reflection.

6. The illumination device as set forth in claim 5, wherein:
each of the reflecting members is a reflecting member for performing two-side diffusion reflection, a reflecting member for performing diffusion reflection by one surface and performing mirror reflection by an opposing surface, or a reflecting member for performing two-side mirror reflection.

7. An illumination device, comprising:
a plurality of combinations of a light source and a light guide for causing surface emission of light that comes from the light source; and
reflecting members, each of which faces and covers that surface of corresponding one of the light guides which is an opposing surface of a light emitting surface, the each of the reflecting members being configured to extend out into a gap between corresponding two of the light guides which are arranged adjacently to one another so as not to overlap with one another, and the reflecting members being configured not to overlap with their adjacent ones, in a normal direction of a light emitting surface, in a gap between corresponding two of the light guides that are arranged adjacently to one another so as not to overlap with one another.

8. The illumination device as set forth in claim 7, wherein:
each of the light guides includes (i) a light emitting section having the light emitting surface and (ii) a light guiding section for directing, to the light emitting section, the light that comes from a corresponding light source; and
the light guides are arranged so that a light emitting section of one of adjacent two of the light guides is placed on a light guiding section of the other one of the adjacent two of the light guides.

9. The illumination device as set forth in claim 7, wherein:
each of the reflecting members (i) extends out, by a first width, from one end of corresponding one of the light guides in a direction in which the light guides are arranged adjacently to one another so as not to overlap with one another, and (ii) extends out, by a second width smaller than the first width, from an opposing end of the corresponding one of the light guides in the direction.

10. The illumination device as set forth in claim 8, wherein:
each of the reflecting members extends out over a gap between corresponding two of the light guides which are arranged adjacently to one another so as to overlap with one another.

11. The illumination device as set forth in claim 7, wherein:
each of the reflecting members performs two-side reflection.

12. The illumination device as set forth in claim 11, wherein:
each of the reflecting members is a member for performing two-side diffusion reflection, a member for performing diffusion reflection by one surface and performing mirror reflection by an opposing surface, or a member for performing two-side mirror reflection.

13. A liquid crystal display device, comprising, as a backlight, an illumination device as recited in claim 1.

14. A television receiver device comprising:
a built-in tuner; and
a backlight, which is an illumination device as recited in claim 1.

15. A liquid crystal display device, comprising, as a backlight, an illumination device as recited in claim 7.

16. A television receiver device comprising:
a built-in tuner; and
a backlight, which is an illumination device as recited in claim 7.
